(19) United States
(12) Patent Application Publication
(10) Pub. No.: US 2026/0160140 A1
(43) Pub. Date: Jun. 11, 2026

(54) Automated System and Modular Jet Ring Assembly for Breaking Down Solids in Oilwells Sumps or Cellars

(71) Applicant: Brandon Kraatz, Victoria, TX (US)

(72) Inventor: Brandon Kraatz, Victoria, TX (US)

(21) Appl. No.: 18/973,446

(22) Filed: Dec. 9, 2024

(51) Int. Cl. E21B 21/06; B02C 19/18

(52) U.S. Cl. CPC E21B 21/06; B02C 19/063

(57) ABSTRACT

Disclosed is an automated system for breaking down large solids and earth materials into a pumpable slurry consistency within a sump or cellar during oil drilling operations. The system features a modular jet ring assembly composed of segmented attachments that can be installed around existing wellhead equipment and drill pipes. Each segment includes high-pressure jet nozzles strategically positioned to eject water radially inward, breaking down accumulated solids into a manageable slurry. The jet ring is connected to an external water supply line and operates in conjunction with a “run dry” capable water pump to evacuate the slurry from the sump or cellar. The modular design allows for easy installation in confined spaces, providing comprehensive coverage of the sump area while minimizing manual intervention. This invention enhances operational efficiency, reduces safety risks, and is applicable to other industries requiring efficient solid-to-slurry conversion.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of automated systems for breaking down large solids and earth materials into a pumpable slurry within a sump or cellar during oil drilling operations. In one embodiment, the system utilizes a modular jet ring assembly that can be installed around existing wellhead equipment to efficiently convert problematic solids into a manageable consistency.

### Background of the Invention

An oilwell sump or cellar is a crucial below-ground structure used in oil and gas drilling operations. It is typically a dug-out area located beneath the drilling rig. During the oilwell drilling processes dirt and other earth materials often fall into the sump or cellar due to the disturbance caused by the drilling activities. This accumulation of solids can create significant challenges for drilling operations, as it can lead to clogging and hinder access to the well.

Traditionally, maintaining the sump or cellar has required manual intervention to remove these large solid materials. Manual intervention can be labor-intensive and time-consuming. So, a need exists for systems of a system for breaking down large solids and earth materials.

### Listing of Related Art

U.S. Pat. No. 168,278—Dredging apparatus
U.S. Pat. No. 2,018,285—Method for developing water wells
U.S. Pat. No. 2,465,562—Vehicle washer
U.S. Pat. No. 2,619,180—Apparatus for pressurizing liquid and cleaning well holes
U.S. Pat. No. 2,754,834—Automated vehicle washing machine
U.S. Pat. No. 2,665,171—Spray forming shower tube
U.S. Pat. No. 6,273,512—Hydrovac excavating blast wand
U.S. Pat. No. 5,140,759—Pneumatic device for excavating and removing material
U.S. Pat. No. 6,446,365—Soft excavation patent
U.S. Pat. No. 4,688,648—Method of and apparatus for crushing earth under the ground
U.S. Pat. No. 6,470,605—Earth reduction tool
U.S. Pat. No. 7,080,484—Plant watering system
U.S. Pat. No. 10,369,578—Tubular shower apparatus, systems and methods
U.S. Pat. No. 9,999,894—Tree and shrub sprinkler apparatus
U.S. Pat. No. 11,028,556—Method and device for exposing a utility buried below a roadway
U.S. Pat. No. 11,382,284—Tree watering apparatus
U.S. Pat. No. 10,718,105—Handwashing station
US20140020268A1—System and method to excavate using pneumatic shock wave
US20140373399A1—Excavation system using vacuum truck
US20230080378A1—Automated dual excavation system for hydro/pneumatic vacuum excavators
EP1083266A2—Fitting for personal hygiene
CN211881871U—Atomizer device for garden engineering
FR2724550A1—Curved arc forming jets of water for a shower
CN113207628A—Insect prevention ring irrigation device
GB2138707A—Hydro-massage device
JPH08289675A—Tree guard with integrated sprinkling device
U.S. D399712—Tree waterer
U.S. D833693—Car wash reach arch
U.S. D862641—Irrigation device

### SUMMARY OF THE INVENTION

Disclosed is a system for breaking down large solids and earth materials into a pumpable slurry consistency within a sump or cellar during oil drilling operations, particularly during the “surface” section of well drilling (0′-4000′ depth). The core component is a segmented jet ring. In one embodiment, the segmented jet ring can be assembled around existing wellhead equipment and drill pipes, forming a complete circle or other annulus when installed inside the cellar or sump.

In the preferred embodiment, the jet ring has an 84″ diameter and is raised 8″ via pipe stands or footers. Its modular nature allows for easy installation in confined spaces and around existing drilling equipment. Once assembled, the jet ring connects to an external water supply line, pressurizing water that is forcefully ejected through strategically placed nozzles along the inside of the ring.

The high-pressure water jets break down large solid earth materials that accumulate during drilling operations, converting them into a slurry consistency manageable by standard pumping equipment. The system works with an external “run dry” capable water pump to evacuate the slurry, creating an automated process requiring minimal human intervention beyond initial deployment and setup.

This automated system offers several advantages over existing methods: comprehensive coverage of the sump area, unlike labor-intensive manual approaches or inefficient submersible pump-mounted jet rings; prevention of clogging and packing off due to rapid accumulation of large solids from fast drilling operations; improved efficiency and reduced safety risks by allowing drilling personnel to focus on core job duties; and, potential applications beyond oil and gas drilling, including the mining industry and other scenarios requiring efficient conversion of large solid materials to pumpable slurry. By addressing a common industry problem with a novel, efficient, and automated solution, this invention has the potential to significantly improve operations in oil drilling and related industries where managing large solid materials in confined spaces is a persistent challenge.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective view of a modular jet nozzle attachment;

FIG. 2 is a bottom view of the nozzle attachment;

FIG. 3 is a top view of the nozzle attachment;

FIG. 4 is a front view of the nozzle attachment;

FIG. 5 is a rear view of the nozzle attachment;

FIG. 6 is a left-side view of the nozzle attachment;

FIG. 7 is a right-side view of the nozzle attachment.

FIG. 8 is an assembly of modular jet nozzle attachments into a ring;

FIG. 9 is a cross-section view of a sump or cellar with an assembly;

FIG. 10 is a second cross-section view of or cellar with an assembly;

FIG. 11 is a third cross-section view of a sump or cellar with an assembly;

FIG. 12 is a fourth cross-section view of a sump or cellar with an assembly; and,

FIG. 13 is a blue print of the modular jet nozzle attachment.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed a preferred embodiment of a system for breaking down large solids and earth materials into a pumpable slurry consistency within a sump or cellar during oil drilling operations. Also disclosed is a preferred embodiment of a modular jet nozzle attachment that may be assembled around existing wellhead equipment and drill pipes to create a ring of jets radially directed toward a center point of a sump or cellar housing the equipment and drill pipes. The more specific details of the system and jet nozzle attachment are disclosed in connection with the appended figures.

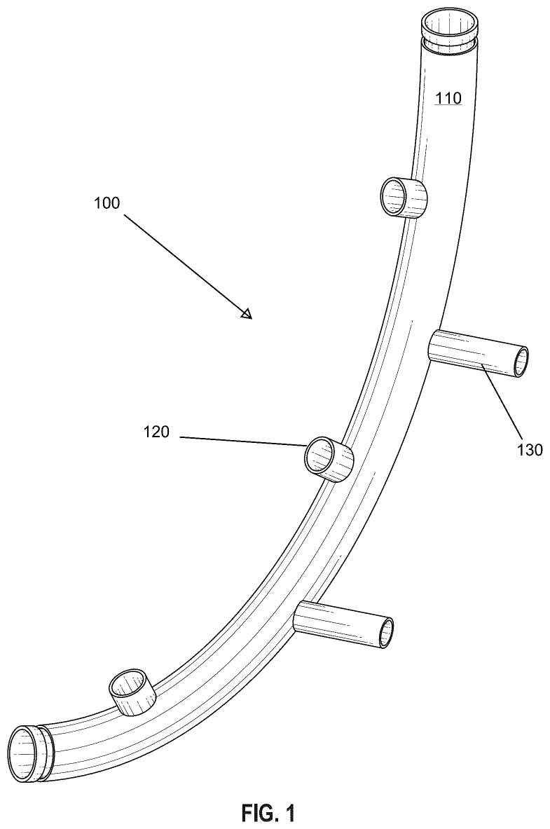

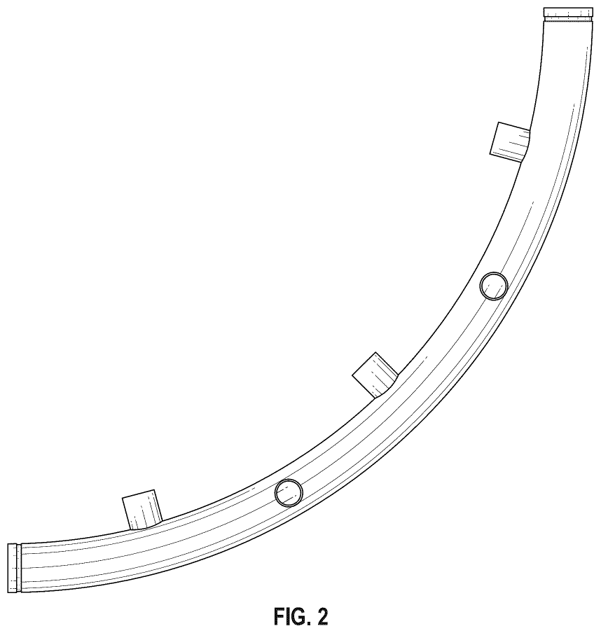

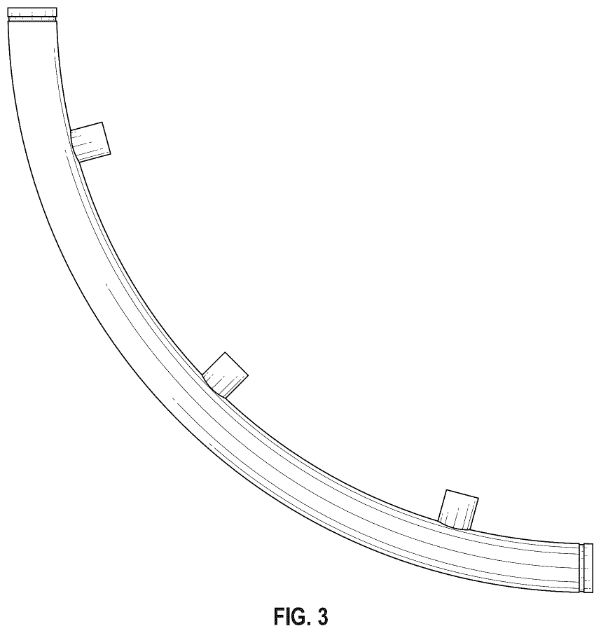

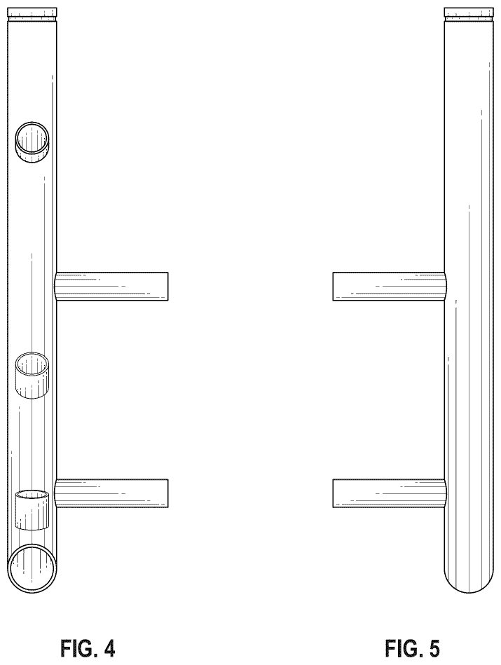

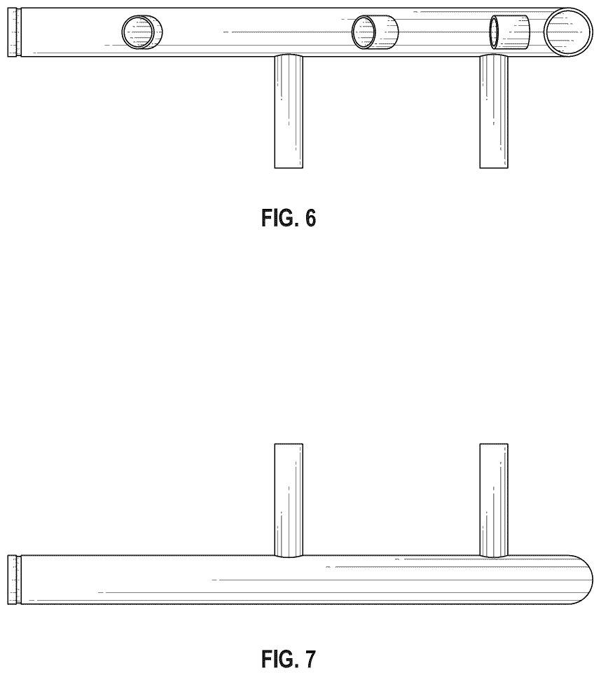

FIG. 1 is a perspective view of a preferred version or embodiment of a modular jet nozzle attachment 100. FIGS. 2 through 7 are respectively bottom, top, front, rear, left-side, and right-side views of the nozzle attachment 100. As shown, the preferred attachment is a semi-circular tube 110 with at least one jet nozzle 120 projecting radially of the semi-circular tube 110 and pointed generally toward the focal point of the semi-circle. Also shown is two footers 113 generally positioned in a normal direction relative to the nozzle 120.

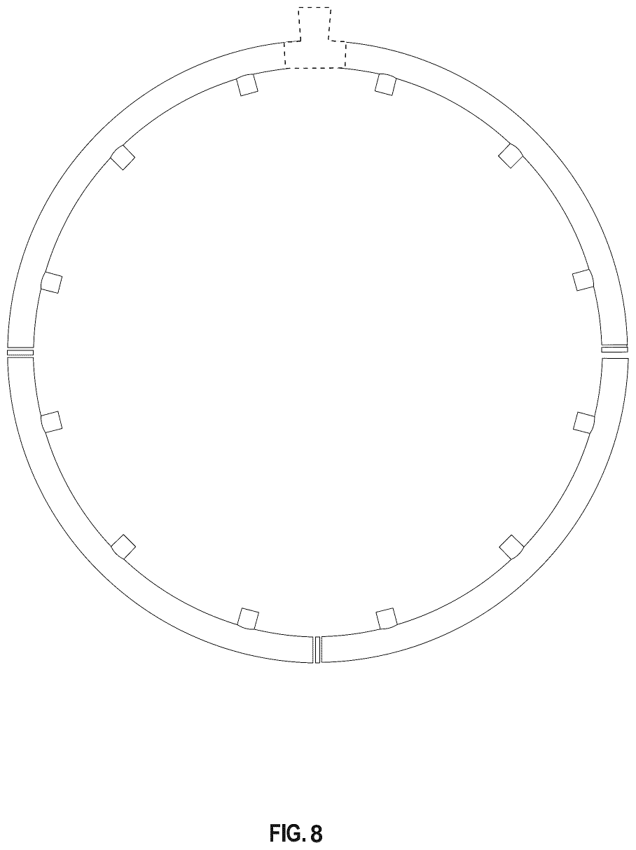

Still referring to FIGS. 1 through 7, it can be observed that the preferred embodiment of the nozzle attachment 100 features two ends of the semi-circular tube 110. The two ends of the semi-circular tube 110 suitably each feature a Hammer union connection so that the attachment may be attached to a pressurized water hose, another attachment, or both (e.g. via a t-coupling). In other embodiments, the tube 110 may feature Victaulic coupling groove (VCG) on the ends as an alternative connection mechanism. As discussed in further detail below in connection with FIG. 8, the preferred embodiment of the assembly may be coupled as set of attachments 100 in a circle and coupled to a pressurized hose of water (not shown) so that high-pressure jets of water may be sprayed from the nozzles 120 of the attachments 1000.

Although the preferred embodiment of the attachment 100 features three nozzles 120, two footers 130, and a tube 110 that is approximately one quarter of a circle, it should be understood that there can be more or less than three nozzles 120, more or less than two footers 130, and a larger or smaller fractional semi-circular of the tube 110. The nozzles may be directed radially as shown or some other angle between the radial direction and the normal upward direction. Finally, the footers should generally be oriented downward in the generally normal direction although variations to that direction may still be employed in alternative versions without departing from the spirit and intent of this disclosure.

FIG. 8 is a plan view of a set of modular jet nozzle attachments 100. When assembled as shown, the attachments form a ring of semi-circular tubes 110 with jet nozzles 120 pointed inward toward a focal point. In one version, the ring of tubes 110 may be coupled to a pressurized source of water (not shown) so that high-pressure jets of water may be sprayed at the focal point of the annular assembly of attachments 100. Although the assembly is shown as a circular ring, other version of the assembly may be square, pentagonal, hexagonal, heptagonal, octagonal, nonagonal, decagonal and so on up to and approaching circular.

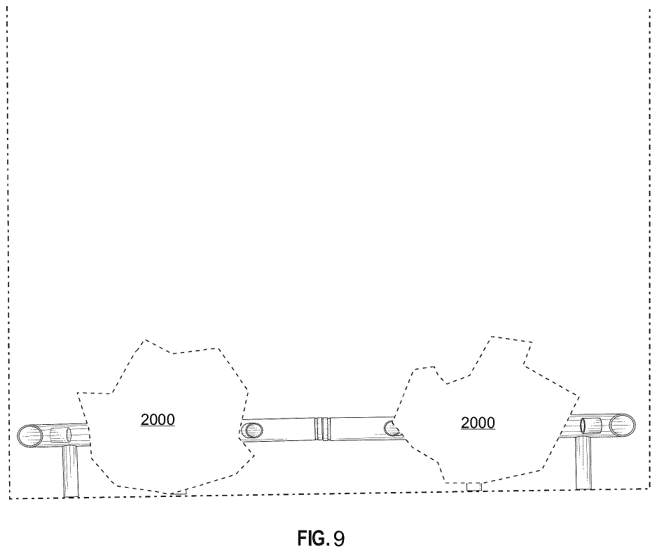

FIG. 9 shows an environmental, cross view of the assembly of attachments 100 of FIG. 8. In this version of the assembly, the attachments 100 are designed to be coupled to a high-pressure water source (not shown) and, referring to FIG. 9, installed inside the cellar or sump, forming a complete ring once all segments are connected. In the preferred embodiment, the diameter of the jet ring is 84″ and the ring is raised 8″ via the attachments' footers 130. The modular nature of the ring allows for easy installation in confined spaces and around existing drilling equipment (not shown).

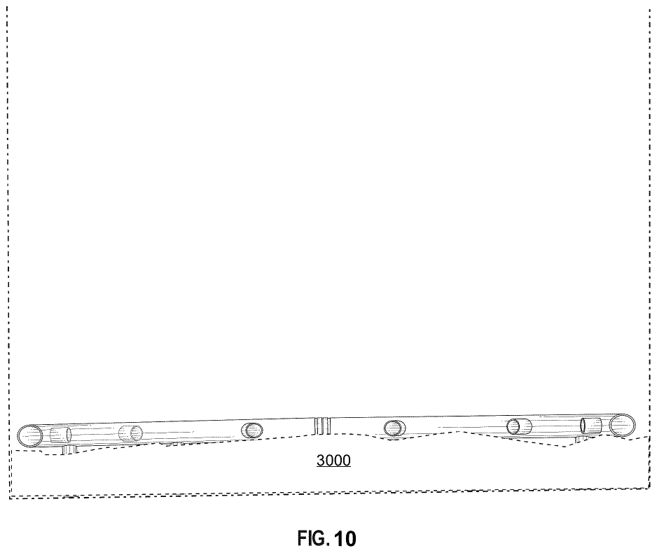

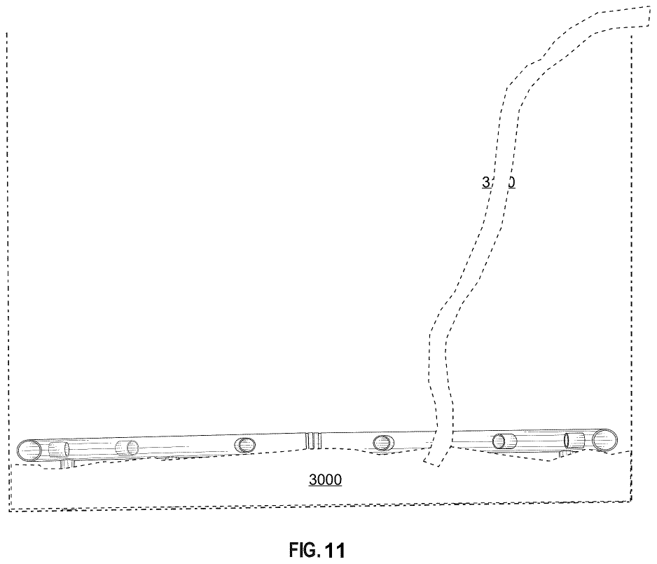

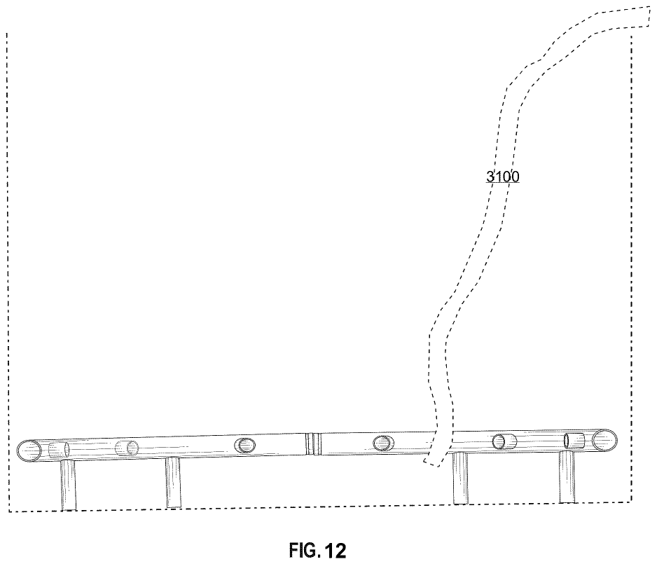

FIG. 10 shows an environmental, cross section view of the assembly of attachments 100 of FIG. 8. As discussed above, ring may be connected to an external water supply line (not shown). This connection pressurizes the water, which is then forcefully ejected through strategically placed nozzles 120 along the inside of the ring. The high-pressure water jets serve to break down the large solid earth materials 2000 that accumulate in the sump or cellar during drilling operations. As discussed further below, in connection with FIGS. 11 and 12, the above described preferred process effectively converts the problematic large solids 2000 into a slurry 3000 that can be easily managed by standard pumping equipment (e.g., hose 3100 and pump (not shown)).

Referring to FIGS. 11 and 12, the system is suitably configured to work in conjunction with an external “run dry” (i.e., run with little to no water in the equipment) water pump. This pump may be used to evacuate the slurry 3000 from the sump or cellar, creating an automated system that requires minimal human intervention. The annular arrangement ensures that water jets can reach and break down solids throughout the entire cellar, preventing clogging and packing off that often occurs due to the rapid accumulation of large solids from fast drilling operations. The automated nature of this system allows drilling personnel to focus on their core job duties, improving overall efficiency and potentially reducing safety risks associated with manual intervention in the sump area.

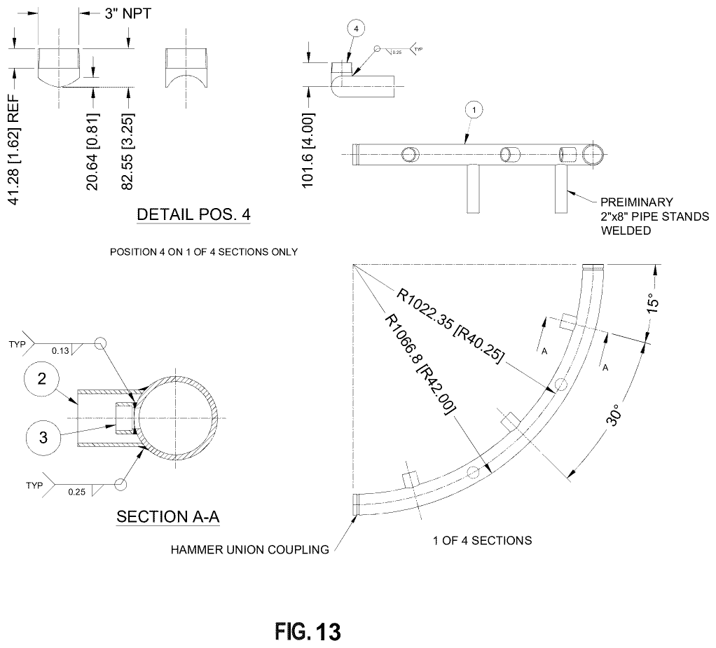

FIG. 13 is a blue print of the modular jet nozzle attachment 100. In the blue print, the primary dimensions and tolerances are called out in millimeters (mm). The general fabrication tolerances are in mm unless otherwise stated. The linear dimensions are in mm and the nominal dimensions are 0 mm to 30 mm±1, >30 mm to 120 mm±2, >120 mm to 315 mm±2, >315 mm to 1000 mm±3, >1000 mm to 2000 mm±4, >2000 mm to 4000 mm±6. All burs, sharp corners, and weld splatters should be removed. Additionally: Pos. 4 denotes an carbon steel pipe/sch. 40/Ø3″×3.25″ lg; Pos. 3 denotes an carbon steel ¾″ NPT pipe half coupling; Pos. 2 denotes an carbon steel pipe/Sch. 40 Ø2″×2.5″ lg; and Pos. 1 denotes an carbon steel ring, Pipe/Sch. 40/Ø3″×1606 mm lg. Alternative embodiments could be made of aluminum parts.

In sum, the general disclosure relates to an automated system for breaking down large solids and earth materials into a pumpable slurry consistency within a sump or cellar during oil drilling operations. One component is a modular jet ring assembly composed of segmented attachments that can be installed around existing wellhead equipment and drill pipes. Each segment includes high-pressure jet nozzles strategically positioned to eject water radially inward, breaking down accumulated solids into a manageable slurry. The jet ring, with a preferred diameter of 84 inches, is raised 8 inches via pipe stands or footers and connected to an external water supply line. It operates in conjunction with a “run dry” capable water pump to evacuate the slurry from the sump or cellar. This system automates the previously manual maintenance process, providing comprehensive coverage of the sump area and preventing clogging and packing off that often occurs due to rapid accumulation of large solids from fast drilling operations. The modular design allows for easy installation in confined spaces, minimizing manual intervention and improving operational efficiency. The invention's applicability extends beyond oil and gas drilling, with potential uses in the mining industry and other scenarios where large solid materials need to be efficiently converted to a pumpable slurry. By addressing a common industry problem with a novel, efficient, and automated solution, this invention has the potential to significantly improve operations in oil drilling and related industries where the management of large solid materials in confined spaces is a persistent challenge.

In one embodiment, the invention comprises a system for breaking down solids in a sump or cellar during oil drilling operations. The system includes a modular jet ring assembly configured to be installed around existing wellhead equipment. The modular jet ring assembly comprises a plurality of jet nozzles positioned along the jet ring assembly. The system also includes a water supply line connected to the jet ring assembly and a pump configured to evacuate slurry from the sump or cellar.

The modular jet ring assembly comprises a plurality of segmented attachments that form a complete circle when connected. Each segmented attachment comprises a semi-circular tube with at least one jet nozzle projecting radially inward. In a preferred embodiment, the jet ring assembly has a diameter of approximately 84 inches.

The system further includes a plurality of footers configured to raise the jet ring assembly above a bottom surface of the sump or cellar. In one embodiment, the footers are configured to raise the jet ring assembly approximately 8 inches above the bottom surface. The pump used in the system is preferably a “run dry” capable water pump.

In another embodiment, the invention comprises a method for breaking down solids in a sump or cellar during oil drilling operations. The method includes assembling a modular jet ring around existing wellhead equipment in the sump or cellar and connecting the jet ring to a water supply line. The method further involves pressurizing water through the jet ring to eject high-pressure water jets from nozzles positioned along the jet ring. This process breaks down solid materials in the sump or cellar into a slurry using the high-pressure water jets. Finally, the method includes evacuating the slurry from the sump or cellar using a pump.

The step of assembling the modular jet ring comprises connecting a plurality of segmented attachments to form a complete circle. The method also includes raising the jet ring above a bottom surface of the sump or cellar using a plurality of footers. Breaking down solid materials comprises directing the high-pressure water jets radially inward toward a center of the sump or cellar.

The method of evacuating the slurry comprises using a “run dry” capable water pump. The system can be operated continuously to maintain the sump or cellar free of large solid materials. Assembling the modular jet ring includes installing the jet ring around a drill pipe and wellhead equipment. Breaking down solid materials comprises converting earth materials accumulated during drilling operations into a pumpable slurry consistency. The method minimizes human intervention in maintaining the sump or cellar during drilling operations.

In yet another embodiment, the invention comprises a modular jet nozzle attachment for use in a system for breaking down solids in a sump or cellar. The attachment includes a semi-circular tube configured to couple with other similar attachments to form a complete circular jet ring. The attachment has at least one jet nozzle projecting radially inward from the semi-circular tube. It also includes coupling mechanisms at each end of the semi-circular tube for connecting to adjacent attachments or a water supply line. The attachment further comprises at least one footer extending from the semi-circular tube for elevating the attachment above a surface.

The coupling mechanisms of the modular jet nozzle attachment comprise Hammer union connections. In one embodiment, the attachment comprises three jet nozzles positioned along the semi-circular tube. The semi-circular tube is approximately one quarter of a circle in length.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A system for breaking down solids in a sump or cellar during oil drilling operations, comprising:
a modular jet ring assembly configured to be installed around existing wellhead equipment;
a plurality of jet nozzles positioned along the jet ring assembly;
a water supply line connected to the jet ring assembly; and
a pump configured to evacuate slurry from the sump or cellar.

2. The system of claim 1, wherein the modular jet ring assembly comprises a plurality of segmented attachments that form a complete circle when connected.

3. The system of claim 2, wherein each segmented attachment comprises a semi-circular tube with at least one jet nozzle projecting radially inward.

4. The system of claim 1, wherein the jet ring assembly has a diameter of approximately 84 inches.

5. The system of claim 1, further comprising a plurality of footers configured to raise the jet ring assembly above a bottom surface of the sump or cellar.

6. The system of claim 5, wherein the footers are configured to raise the jet ring assembly approximately 8 inches above the bottom surface.

7. The system of claim 1, wherein the pump is a “run dry” capable water pump.

8. A method for breaking down solids in a sump or cellar during oil drilling operations, comprising:
assembling a modular jet ring around existing wellhead equipment in the sump or cellar;
connecting the jet ring to a water supply line;
pressurizing water through the jet ring to eject high-pressure water jets from nozzles positioned along the jet ring;
breaking down solid materials in the sump or cellar into a slurry using the high-pressure water jets; and
evacuating the slurry from the sump or cellar using a pump.

9. The method of claim 8, wherein assembling the modular jet ring comprises connecting a plurality of segmented attachments to form a complete circle.

10. The method of claim 8, further comprising raising the jet ring above a bottom surface of the sump or cellar using a plurality of footers.

11. The method of claim 8, wherein breaking down solid materials comprises directing the high-pressure water jets radially inward toward a center of the sump or cellar.

12. The method of claim 8, wherein evacuating the slurry comprises using a “run dry” capable water pump.

13. The method of claim 8, further comprising continuously operating the system to maintain the sump or cellar free of large solid materials.

14. The method of claim 8, wherein assembling the modular jet ring comprises installing the jet ring around a drill pipe and wellhead equipment.

15. The method of claim 8, wherein breaking down solid materials comprises converting earth materials accumulated during drilling operations into a pumpable slurry consistency.

16. The method of claim 8, further comprising minimizing human intervention in maintaining the sump or cellar during drilling operations.

17. A modular jet nozzle attachment for use in a system for breaking down solids in a sump or cellar, comprising:
a semi-circular tube configured to couple with other similar attachments to form a complete circular jet ring;
at least one jet nozzle projecting radially inward from the semi-circular tube;
coupling mechanisms at each end of the semi-circular tube for connecting to adjacent attachments or a water supply line; and
at least one footer extending from the semi-circular tube for elevating the attachment above a surface.

18. The modular jet nozzle attachment of claim 17, wherein the coupling mechanisms comprise Hammer union connections.

19. The modular jet nozzle attachment of claim 17, comprising three jet nozzles positioned along the semi-circular tube.

20. The modular jet nozzle attachment of claim 17, wherein the semi-circular tube is approximately one quarter of a circle in length.
